(19) United States
(12) Patent Application Publication
(10) Pub. No.: US 2026/0340475 A1
(43) Pub. Date: Oct. 29, 2026

(54) AI/ML MODEL QUALITY MONITORING AND FAST RECOVERY UNDER MODEL FAILURE DETECTION

(71) Applicant: APPLE INC., Cupertino, CA (US)

(72) Inventors: Peng Cheng, Beijing (CN); Ping-Heng Kuo, London (GB); Alexander Sirotkin, Hod Hasharon (IL); Fangli Xu, Beijing (CN); Huaning Niu, San Jose, CA (US); Haijing Hu, Los Gatos, CA (US); Ralf Rossbach, Munich (DE)

(21) Appl. No.: 19/103,613

(22) PCT Filed: Aug. 26, 2022
(86) PCT No.: PCT/CN2022/115195

§ 371 Date: Feb. 13, 2025

(51) Int. Cl. G06N 20/00; H04W 8/24

(52) U.S. Cl. CPC G06N 20/00; H04W 8/24

(57) ABSTRACT

AI/ML model quality monitoring and fast recovery under model failure detection are disclosed. A UE may receive a training quality enquiry message from a network device, wherein the training quality enquiry message comprises enquiry information about one or more training quality metrics for training one or more AI models of the UE; and transmit a training quality response message to the network device, wherein the training quality response message comprises response information about the one or more training quality metrics for training the one or more AI models of the UE.

### TECHNICAL FIELD

This application relates generally to wireless communication systems, including Artificial Intelligence (AI)/Machine Learning (ML) model quality monitoring and fast recovery under model failure detection.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a or g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 GHz frequencies, some of which are bands that may be used by previous standards, and may potentially be extended to cover new spectrum offerings from 410 MHz to 7125 MHz. Frequency Range 2 (FR2) may include frequency bands from 24.25 GHz to 52.6 GHz. Bands in the millimeter wave (mmWave) range of FR2 may have smaller coverage but potentially higher available bandwidth than bands in the FR1. Skilled persons will recognize these frequency ranges, which are provided by way of example, may change from time to time or from region to region.

### SUMMARY

The present disclosure provides apparatus, systems, and methods for Artificial Intelligence (AI)/Machine Learning (ML) model quality monitoring and fast recovery under model failure detection.

According to some embodiments, a user equipment (UE) is disclosed, comprising: at least one antenna; at least one radio coupled to the at least one antenna; and a processor coupled to the at least one radio; the processor being configured to: receive a training quality enquiry message from a network device, wherein the training quality enquiry message comprises enquiry information about one or more training quality metrics for training one or more AI models of the UE; and transmit a training quality response message to the network device, wherein the training quality response message comprises response information about the one or more training quality metrics for training the one or more AI models of the UE.

According to some embodiments, a network device is disclosed, comprising: at least one antenna; at least one radio coupled to the at least one antenna; and a processor coupled to the at least one radio; the processor being configured to: transmit a training quality enquiry message to a UE, wherein the training quality enquiry message comprises enquiry information about one or more training quality metrics for training one or more AI models of the UE; and receive a training quality response message from the UE, wherein the training quality response message comprises response information about the one or more training quality metrics for training the one or more AI models of the UE.

According to some embodiments, a user equipment (UE) is disclosed, comprising: at least one antenna; at least one radio coupled to the at least one antenna; and a processor coupled to the at least one radio; the processor being configured to: detect a failure status of a first AI model of the UE; and switch to a second AI model that is different from the first AI model.

According to some embodiments, a network device is disclosed, comprising: at least one antenna; at least one radio coupled to the at least one antenna; and a processor coupled to the at least one radio; the processor being configured to: receive, from a UE, a failure status of a first AI model of the UE; and send a switch indication to the UE for switch to a second AI model that is different from the first AI model.

According to some embodiments, a non-transitory computer-readable storage medium is disclosed, having instructions stored thereon, which, when executed by a processor of a device, cause the processor to perform the method or steps described herein.

According to some embodiments, a computer program product is disclosed, having a computer program stored thereon, which, when executed by a processor of a device, cause the processor to perform the method or steps described herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates an example system for performing signaling between a wireless device and a network device, according to embodiments disclosed herein.

FIG. 3 illustrates an example functional framework of AI/ML in wireless communication systems, according to embodiments disclosed herein.

FIG. 4 illustrates an example process for performing training quality negotiation between a UE and a network device, according to embodiments disclosed herein.

FIG. 5 illustrates an example communication procedure for performing training quality negotiation between a UE and a network device, according to embodiments disclosed herein.

FIG. 6 illustrates an example process for performing fast recovery under model failure detection, according to embodiments disclosed herein.

FIG. 7 illustrates an example communication procedure for performing fast recovery under model failure detection, according to embodiments disclosed herein.

FIG. 8 illustrates another example communication procedure for performing fast recovery under model failure detection, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

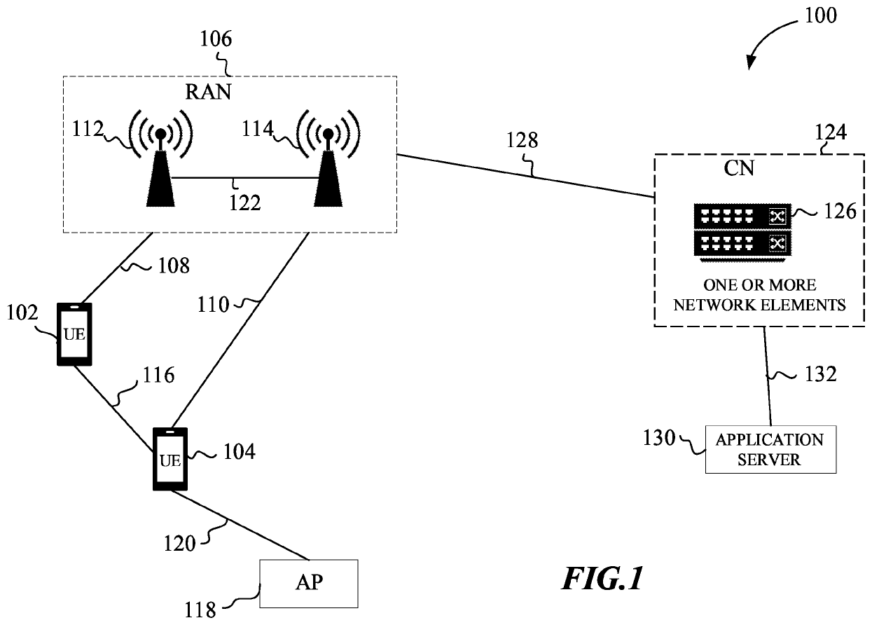

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes UE 102 and UE 104 (although any number of UEs may be used). In this example, the UE 102 and the UE 104 are illustrated as smartphones (e.g., handheld touchscreen mobile computing devices connectable to one or more cellular networks), but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112 and base station 114, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface 116. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 and/or the base station 114 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 112 or base station 114 may be implemented as one or more software entities running on server computers as part of a virtual network. In addition, or in other embodiments, the base station 112 or base station 114 may be configured to communicate with one another via interface 122. In embodiments where the wireless communication system 100 is an LTE system (e.g., when the CN 124 is an EPC), the interface 122 may be an X2 interface. The X2 interface may be defined between two or more base stations (e.g., two or more eNBs and the like) that connect to an EPC, and/or between two eNBs connecting to the EPC. In embodiments where the wireless communication system 100 is an NR system (e.g., when CN 124 is a 5GC), the interface 122 may be an Xn interface. The Xn interface is defined between two or more base stations (e.g., two or more gNBs and the like) that connect to 5GC, between a base station 112 (e.g., a gNB) connecting to 5GC and an eNB, and/or between two eNBs connecting to 5GC (e.g., CN 124).

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 or base station 114 and a serving gateway (S-GW), and the S1-MME interface, which is a signaling interface between the base station 112 or base station 114 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 or base station 114 and a user plane function (UPF), and the S1 control plane (NG-C) interface, which is a signaling interface between the base station 112 or base station 114 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VOIP sessions, group communication sessions, etc.) for the UE 102 and UE 104 via the CN 124. The application server 130 may communicate with the CN 124 through an IP communications interface 132.

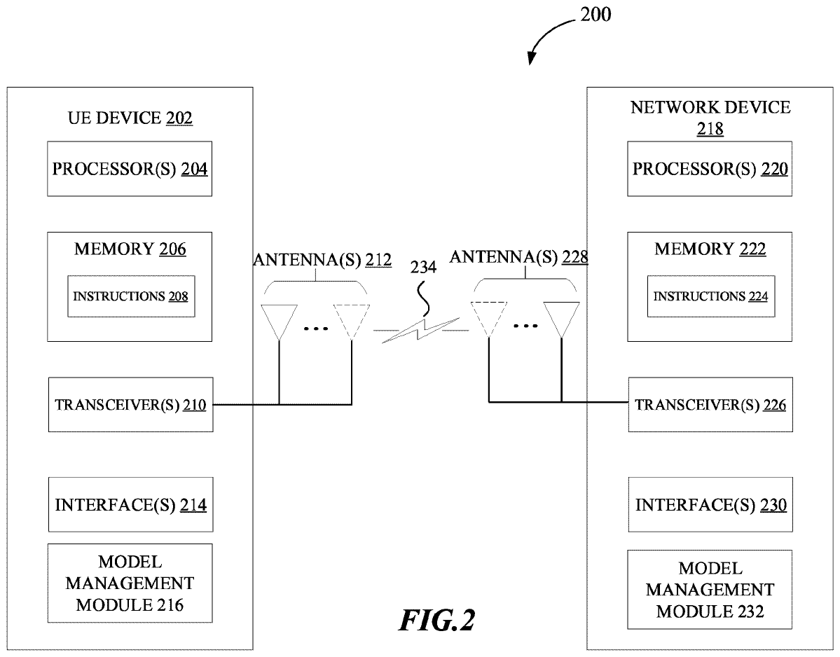

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs. The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The wireless device 202 may include a model management module 216. The model management module 216 may be implemented via hardware, software, or combinations thereof. For example, the model management module 216 may be implemented as a processor, circuit, and/or instructions 208 stored in the memory 206 and executed by the processor(s) 204. In some examples, the model management module 216 may be integrated within the processor(s) 204 and/or the transceiver(s) 210. For example, the model management module 216 may be implemented by a combination of software components (e.g., executed by a DSP or a general processor) and hardware components (e.g., logic gates and circuitry) within the processor(s) 204 or the transceiver(s) 210.

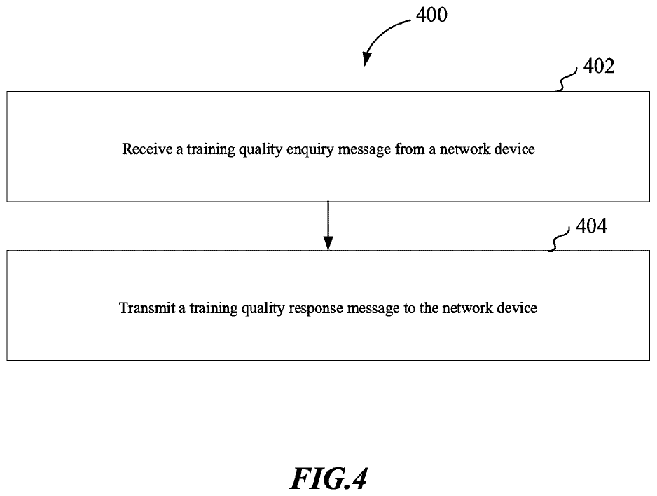

The model management module 216 may be used for various aspects of the present disclosure, for example, aspects of FIGS. 4-8. The model management module 216 is configured to perform model quality negotiation, monitoring and fast recovery under model failure detection for one or more AI/ML models associated with the wireless device 202.

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

The network device 218 may include a model management module 232. The model management module 232 may be implemented via hardware, software, or combinations thereof. For example, the model management module 232 may be implemented as a processor, circuit, and/or instructions 224 stored in the memory 222 and executed by the processor(s) 220. In some examples, the model management module 232 may be integrated within the processor(s) 220 and/or the transceiver(s) 226. For example, the model management module 232 may be implemented by a combination of software components (e.g., executed by a DSP or a general processor) and hardware components (e.g., logic gates and circuitry) within the processor(s) 220 or the transceiver(s) 226.

The model management module 232 may be used for various aspects of the present disclosure, for example, aspects of FIGS. 4-8. The model management module 232 is configured to perform model quality negotiation, monitoring and fast recovery under model failure detection for one or more AI/ML models associated with the wireless devices that are connected to the network device 218.

Embodiments contemplated herein provides AI/ML model quality monitoring and fast recovery under model failure detection in wireless communication systems.

AI techniques described herein may refer to methods, systems or machines that mimic human intelligence to perform tasks and can iteratively improve themselves based on the information they collect. Machine learning (ML) techniques may be a typical sub-domain of AI techniques that is widely used. In the following, ML and AI may be interchangeably used. AI/ML techniques that can be used with the embodiments disclosed herein may involve algorithms, processes, models, and applications that have been designed, are being designed, or will be designed in the future. It is not intended to limit the present disclosure to any specific type of AI/ML technique.

AI/ML techniques may be applied to the wireless communication systems (for example, cellular communication systems) to improve system performance. In some embodiments, AI/ML techniques may be applied to Channel State Information (CSI) feedback enhancement (e.g., overhead reduction, improved accuracy, and prediction). In some embodiments, AI/ML techniques may be applied to Beam Management (BM) (e.g., beam prediction in time, spatial domain for overhead and latency reduction, and beam selection accuracy improvement). In some embodiments, AI/ML techniques may be applied to positioning accuracy enhancements for different scenarios including, e.g., those with heavy NLOS conditions. In still other embodiments, AI/ML techniques may be applied to other aspects of the wireless communication systems. It is readily understood that use cases of AI/ML techniques in the wireless communication systems are not limited to the embodiments disclosed herein.

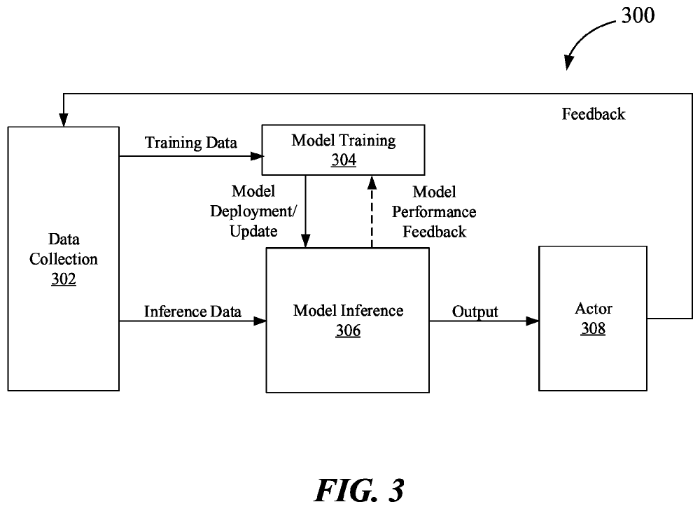

FIG. 3 illustrates an example functional framework 300 of AI/ML in wireless communication systems, according to embodiments disclosed herein. The functional framework 300 may include a Data Collection function 302, a Model Training function 304, a Model Inference function 306, an Actor function 308, and data flows between these functions.

The Data Collection function 302 may be a function that provides input data to Model training and Model inference functions 304 and 306. Examples of input data may include measurements from UEs or different network entities, feedback from Actor, output from an AI/ML model. Training Data may include data that is needed as input for the AI/ML Model Training function 304. Inference Data may include data that is needed as input for the AI/ML Model Inference function 306.

The Model Training function 304 may be a function that performs the AI/ML model training, validation, and testing, which may generate model performance metrics as part of the model testing procedure. The Model Training function 304 may be also responsible for data preparation (e.g., data pre-processing and cleaning, formatting, and transformation) based on Training Data delivered by the Data Collection function 302, if required. Model Deployment/Update is to initially deploy a trained, validated, and tested AI/ML model to the Model Inference function 306 or to deliver an updated model to the Model Inference function 306.

The Model Inference function 306 may be a function that provides AI/ML model inference output (e.g., predictions or decisions). The Model Inference function 306 may provide Model Performance Feedback to the Model Training function 304 when applicable. The Model Inference function 306 may be also responsible for data preparation (e.g., data pre-processing and cleaning, formatting, and transformation) based on Inference Data delivered by the Data Collection function 302, if required. Output is the inference output of the AI/ML model produced by the Model Inference function 306. Details of inference output may be specific to each use case. Model Performance Feedback may be used for monitoring the performance of the AI/ML model, when available.

The Actor function 308 may be a function that receives the output from the Model Inference function 306 and triggers or performs corresponding actions. The Actor function 308 may trigger actions directed to other entities or to itself. Feedback is information that may be needed to derive training data, inference data or to monitor the performance of the AI/ML Model and its impact to the network through updating of KPIs and performance counters.

Functions of the functional framework 300 may be distributed and/or executed in various entities of the wireless communication system, including but not limited to one or more network devices (e.g., base stations), one or more servers of the mobile network operators (MNOs), one or more UEs, and/or one or more servers serving the UEs (e.g., servers provided by manufacturers of the UEs). For example, the Data Collection function 302 may be partly performed at the UEs and/or partly at the network devices, so as to collect training data and/or inference data that may be used for model training and/or inference. The Model Training function 304 may be performed online (e.g., at the UEs) or offline (e.g., at the servers of MNOs or at the servers serving the UEs). The Actor function 308 may involve different actions performed at different entities of the wireless communication system.

Due to complexity of wireless communication systems, it may be challenging to apply AI/ML techniques to the wireless communication systems. For example, the performance of an AI/ML model may depend on implementation of an individual UE for which the AI/ML model is trained and/or will be deployed. Therefore, it might be desired to train and/or deploy the AI/ML model specifically for individual UEs. Also, one AI/ML model that is adapted to (e.g., trained for) a specific wireless environment may not work in a different wireless environment. Due to the randomness of wireless channels and the mobility of UEs, it is difficult for an AI/ML model to maintain optimal performance in all scenarios all the time, and the performance may even deteriorate sharply in some scenarios. It is desired to monitor quality of the AI/ML models and fast recovery from a model failure.

FIG. 4 illustrates an example process 400 for performing training quality negotiation between a UE and a network device, according to embodiments disclosed herein. The process 400 may be performed by the UE, or by a module of the UE. In an example, the process 400 may be performed by processor(s) 204 of the wireless device 202, or be performed by the model management module 216 of the wireless device 202. The network device may be a base station of a cellular network, such as the network device 218 described above.

The process 400 may start with step 402. In this step, the UE may be configured to receive a training quality enquiry message from the network device. The training quality enquiry message may include enquiry information about one or more training quality metrics for training one or more AI/ML models of the UE.

According to embodiments disclosed herein, the enquiry information may include one or more values that are specified by the network device for the one or more training quality metrics. This allows the network device to specify a desired training quality for training the one or more AI/ML models of the UE.

According to embodiments disclosed herein, the one or more AI/ML models of the UE associated with the training quality enquiry message may include various AI/ML models that may be applicable to the UE. Examples of applicable AI/ML models may include AI/ML models that are directed to Channel State Information (CSI) feedback enhancement, Beam Management (BM), positioning accuracy enhancements, as described above. It is readily understood that the applicable AI/ML models are not limited to these use cases.

According to various embodiments, the one or more training quality metrics may include various metrics that may be able to measure/affect the training quality of the one or more AI/ML models of the UE. Examples of the one or more training quality metrics may include but not limited to:
a minimum size of a dataset that is to be used for training the one or more AI/ML models;
a maximum age of a dataset that is allowed to be used for training the one or more AI/ML models;
a time budget for training the one or more AI/ML models;
an allowed number of unwanted presences of missing values in a dataset used for training the one or more AI/ML models; or
an allowed number of unwanted presences of outlier values in a dataset used for training the one or more AI/ML models.

According to embodiments disclosed herein, instead of including the one or more training quality metrics in the enquiry information, the network device may include a training quality class index in the enquiry information. The training quality class index may be a single value that is mapped to, based on a preconfigured mapping table, the intended one or more training quality metrics selected from all possible training quality metrics.

After receiving training quality enquiry message, the process 400 may proceed to step 404. In this step, the UE may be configured to transmit a training quality response message to the network device. The training quality response message may include response information about the one or more training quality metrics for training the one or more AI/ML models of the UE.

According to embodiments disclosed herein, the response information may include a rejection indication or an acceptance indication that is provided by the UE with respect to at least one of the one or more values specified by the network device for the one or more training quality metrics. In optional embodiments, the response information in the training quality enquiry message may also include one or more values that are acceptable by the UE for at least one of the one or more training quality metrics.

According to embodiments disclosed herein, the training quality enquiry message and the training quality response message may be a pair of Radio Resource Control (RRC) messages.

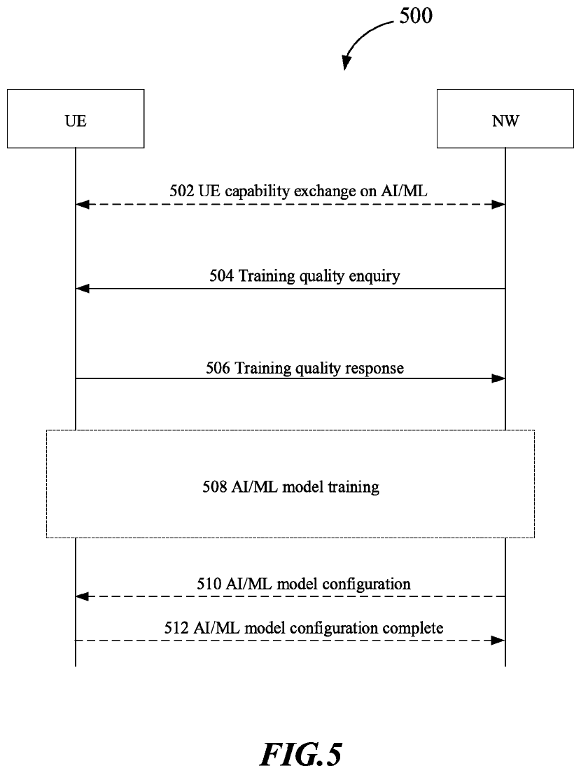

Process 400 allows negotiation between the UE and the network device for the training quality of the AI/ML models of the UE. After this process 400, the one or more AI/ML models may be trained with the negotiated one or more training quality metrics, and the one or more trained AI/ML models may be stored (for example, by the UE or other suitable entity of the system) for future use. Additional details about performing training quality negotiation between the UE and the network device are described in combination with FIG. 5 below.

FIG. 5 illustrates a communication procedure 500 for performing training quality negotiation between a UE and a network device, according to embodiments disclosed herein. The UE may be a wireless device (such as the wireless device 202 described above) that is served by the network device. The network device may be a base station of a cellular network, such as the network device 218 described above. The communication procedure 500 may be performed by the UE and the network device, or by modules of the UE and the network device. In an example, the communication procedure 500 may be performed by processor(s) 204 of the wireless device 202 and processor(s) 220 of the network device 218. In another example, the communication procedure 500 may be performed by the model management module 216 of the wireless device 202 and the model management module 232 of the network device 218.

At step 502, the UE and the network device may be configured to exchange the UE's capability on AI/ML. For example, the network device may be configured to send an inquiry to the UE about the UE's capability on applying AI/ML techniques. The UE's capability on applying AI/ML techniques may be associated with the UE's capability to train one or more AI/ML models, and/or the UE's capability to run one or more trained AI/ML models. In response to the inquiry, the UE may be configured to report the UE's capability on AI/ML to the network device, for example, via one or more capability report messages. Step 502 is illustrated with a dashed line, as it is an optional step.

At step 504, the network device may be configured to transmit a training quality enquiry message to the UE. As described above, the training quality enquiry message may include enquiry information about one or more training quality metrics for training one or more AI/ML models of the UE. The training quality enquiry message may be carried in any type of message or signaling that may be sent from the network device to the UE. In a preferred embodiment, the training quality enquiry message may be carried in an RRC message.

The one or more training quality metrics may include various metrics that may be able to measure/affect the training quality of the one or more AI/ML models of the UE In one embodiment, the one or more training quality metrics may include a minimum size of a dataset that is to be used for training the one or more AI/ML models. A dataset that is to be used for training the one or more AI/ML models may be referred as a training dataset. In general, a larger size of training dataset may improve the training quality of the AI/ML models. The minimum size of dataset that is to be used for training the one or more AI/ML models may be generally associated with the lowest acceptable training quality of the one or more AI/ML models.

Additionally or alternatively, the one or more training quality metrics may include a maximum age of a dataset that is allowed to be used for training the one or more AI/ML models. In general, training data that is collected a long time ago may not be suitable to train an AI/ML model for future use, because these data may be obsolete and thus may not be able to reflect the current/future state of the system. The maximum age of dataset that is allowed to be used for training the one or more AI/ML models may be specified to exclude data that has a larger age than the specified maximum age.

Additionally or alternatively, the one or more training quality metrics may include a time budget for training the one or more AI/ML models. This metric may be specified to limit the time duration that may be required to train the AI/ML models. In general, an AI/ML model that is trained with a longer time duration may have a better training quality.

Additionally or alternatively, the one or more training quality metrics may include an allowed number of unwanted presences of missing values in a dataset used for training the one or more AI/ML models. Additionally or alternatively, the one or more training quality metrics may include an allowed number of unwanted presences of outlier values in a dataset used for training the one or more AI/ML models. In general, the unwanted presence of missing or outlier values in the training data may reduce accuracy of the model or lead to a biased model. As a result, inaccurate inference output/predictions may occur if the relationship with other variables is not taken into account correctly during the model training. Therefore, it could be essential to treat missing and outlier values well. The allowed number of unwanted presences of outlier values could be expressed as a tolerance and threshold value.

It is readily understood that the above training quality metrics are merely examples of the one or more training quality metrics. In other embodiments, other training quality metrics that may measure/affect the training quality of the one or more AI/ML models may be used without limitation.

The enquiry information may be generated and used by the network device to specify desired training quality for training the one or more AI/ML models of the UE.

The enquiry information may include an identifier for each of the one or more AI/ML models. For example, the enquiry information may include an identifier of a first AI/ML model and a first set of one or more training quality metrics that may be associated with the first AI/ML model. Additionally, the enquiry information may include an identifier of a second AI/ML model and a second set of one or more training quality metrics that may be associated with the second AI/ML model. The first set of one or more training quality metrics and the second set of one or more training quality metrics may or may not be the same.

For each of the identified AI/ML model and its associated one or more training quality metrics, the enquiry information may include one or more values that are specified by the network device for the one or more training quality metrics. These specified one or more values for the one or more training quality metrics may represent the network device's desired training quality for the UE with respect to the identified AI/ML model. In some embodiments, values specified by the network device for a training quality metric may include a value range that includes a plurality of specified values.

Alternatively, the enquiry information may include a training quality class index. The training quality class index may be a single value that is mapped to, based on a mapping table, the intended one or more training quality metrics selected from all possible training quality metrics. Different training quality class index may be mapped to different subsets of training quality metrics of all possible training quality metrics. The mapping table may be preconfigured. The preconfigured table may be known to both of the network device and the UE, such that the UE may be configured to determine the intended one or more training quality metrics based on the received training quality class index.

In embodiments where the network device has received the UE's capability on AI/ML (for example, in step 502), the one or more AI/ML models that are associated with the enquiry information may be selected, by the network device and from all possible AI/ML models, based on the UE's capability on AI/ML, such that the selected models might be adapted to the UE's capability on AI/ML. Additionally, the one or more training quality metrics may be also determined by the network device based on the UE's capability on AI/ML. Also, the one or more values that are specified by the network device for the one or more training quality metrics may be also determined by the network device based on the UE's capability on AI/ML.

At step 506, the UE may be configured to transmit a training quality response message to the network device, in response to receiving the training quality enquiry message. The training quality response message may include response information about the one or more training quality metrics for training the one or more AI/ML models of the UE. The training quality response message may be carried in any type of message or signaling that may be sent from the UE to the network device. In a preferred embodiment, the training quality response message may be carried in an RRC message.

The response information in the training quality response message may be generated and used by the UE to indicate whether the desired training quality as indicated in the training quality enquiry message is acceptable or not by the UE.

The response information may include an identifier for at least one of the one or more AI/ML models that are included in the training quality enquiry message. For each of the identified AI/ML model, the response information may further include a rejection indication or an acceptance indication that is provided by the UE for at least one of training quality metrics associated with that AI/ML model.

For example, if the UE determines a value that is specified in the enquiry information for one training quality metric of the one or more training quality metrics is acceptable, the UE may provide an acceptance indication in the response information for that training quality metric. If the UE determines a value that is specified in the enquiry information for one training quality metric of the one or more training quality metrics is not acceptable, the UE may provide a rejection indication in the response information for that training quality metric.

According to various embodiments, the UE may be configured to determine whether a value that is specified in the enquiry information for one training quality metric of the one or more training quality metrics is acceptable or not based on various factors. For example, the UE may be configured to make the determination based on at least the implementation of the UE, and/or the current state of the UE.

In some embodiments, the response information in the training quality enquiry message may include a rejection indication or an acceptance indication for each of the training quality metrics that are included in the training quality enquiry message. In other embodiments, the response information may only include a rejection indication for each of the rejected training quality metrics, without any acceptance indication for the acceptable training quality metrics. In alternative embodiments, the response information may only include an acceptance indication for each of the acceptable training quality metrics, without any rejection indication for the rejected training quality metrics.

In optional embodiments, the response information in the training quality enquiry message may include one or more values that are acceptable by the UE for at least one of the one or more training quality metrics. For example, for the rejected training quality metrics, the UE may provide a corresponding value associated with that training quality metric in the response information, thereby indicating the provided value as an acceptable value of the UE with respect to the associated training quality metric.

At step 508, the AI/ML model training may be performed by the UE and/or the network device. The AI/ML model training may be performed under the negotiated one or more training quality metrics. In one embodiment, the negotiated one or more training quality metrics may be determined through steps 504 and 506. Specifically, the network device may determine one or more values for the one or more training quality metrics of the one or more AI/ML models, after receiving the training quality response message at step 506. The network device may therefore configure the AI/ML model training with the determined values for the one or more training quality metrics. In further embodiments, the negotiated one or more training quality metrics may be determined through repeating of steps 504 and 506. For example, steps 504 and 506 may be repeatedly performed until a certain condition (such as no rejection indication is provided in the training quality response message) is satisfied. During the repeating of steps 504 and 506, the UE and the network device may be configured to dynamically modify its desired training quality or acceptable training quality such that they could finally achieve agreement.

According to embodiments disclosed herein, the AI/ML model training of step 508 may be performed online and/or offline, with the negotiated one or more training quality metrics satisfied. The trained one or more AI/ML models may be stored for future use. In one example, the trained AI/ML models may be locally stored at the UE. In another example, the trained AI/ML models may be uploaded to another entity of the system (e.g., the MNO server or the UE server). A trained AI/ML model herein may refer to a set of parameters of a general AI/ML model that have been specifically adjusted and refined for the UE.

With the training quality negotiation described in the process 400 and/or the communication procedure 500, the UE and the network device may be able to negotiate training quality metrics that will be applied in training one or more AI/ML models of the UE. This allows the UE and the network device to achieve preferred training quality, such that the trained AI/ML models may be specifically suitable for each individual UE.

The trained one or more AI/ML models may be applied to the UE for which the training quality has been negotiated. As shown by step 510, the network device may send an AI/ML model configuration message to the UE so as to deploy one or more trained AI/ML models intended for use with the UE. The AI/ML model configuration message may include an identifier of each of the intended AI/ML models, and optionally one or more settings (such as inference quality monitor fields discussed below) associated with that model. Upon receiving the AI/ML model configuration message, the UE may be configured to run the corresponding AI/ML model to collect inference output. The UE may return an AI/ML model configuration complete message to the network device at step 512. The AI/ML model configuration message may be carried in an RRCReconfiguration message and the AI/ML model configuration complete message may be carried in an RRCReconfigurationComplete message. Steps 510 and 512 are illustrated with dashed lines, since they are not necessary for training quality negotiation.

Due to the randomness of wireless channels and the mobility of UEs, it is difficult for an AI/ML model to maintain optimal performance all the time, and the performance may even deteriorate sharply in some scenarios. Specifically, the inference quality of the AI/ML models may degrade when the AI/ML models no longer match the wireless environment where they are used. As such, the AI/ML models fail due to this mismatch. It is desired to monitor quality of the AI/ML models and fast recovery from a model failure.

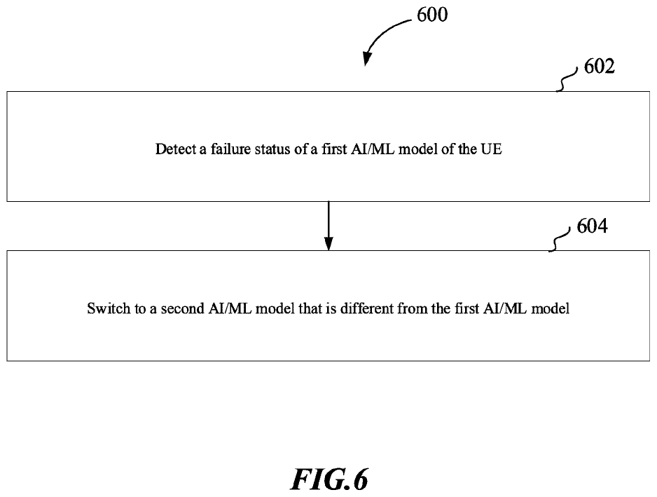

FIG. 6 illustrates a process 600 for performing fast recovery under model failure detection, according to embodiments disclosed herein. The process 600 may be performed by the UE, or by a module of the UE. In an example, the process 600 may be performed by processor(s) 204 of the wireless device 202, or by the model management module 216 of the wireless device 202.

The process 600 may start with step 602. In this step, the UE may be configured to detect a failure status of a first AI/ML model of the UE. The first AI/ML model may be one of the AI/ML models that are currently running with the UE.

In some embodiments, the UE may detect the failure status by determining values for one or more inference quality metrics of the first AI/ML model do not match one or more first preconfigured threshold values for the one or more inference quality metrics. Examples of the one or more inference quality metrics may include: inference accuracy of the first AI/ML model; inference integrity of the first AI/ML model, which is associated with likelihood that a prediction error of the first AI/ML model exceeds a threshold; or inference latency of the first AI/ML model.

For example, the UE may be configured to use collected ground truths labels and inference output of the first AI/ML model to calculate the values for the one or more inference quality metrics of the first AI/ML model. The calculated values may be compared against the one or more first preconfigured threshold values. The one or more first preconfigured threshold values may be preconfigured by the network device, for example, at the time of deploying the first AI/ML model for use with the UE.

In a preferred embodiment, a time-to-trigger mechanism may be used, such that the failure status is detected only if the values for the one or more inference quality metrics of the first AI/ML model fail to match the one or more first preconfigured threshold values for a preconfigured time duration.

In response to detecting the failure status of the first AI/ML model, the UE may be configured to send, to the network device, model failure information associated with the first AI/ML model. The model failure information may be sent via various type of messages from the UE to the network device, for example, an RRC message or a MAC CE (MAC Control Element) message. In an embodiment, the RRC message may be a UE Assistance Information (UAI) message.

In optional embodiments, the model failure information may further indicate one or more candidate AI/ML models that are preferred by the UE. The one or more candidate AI/ML models that are preferred by the UE may be determined based on various factors, such as implementation of the UE.

After sending the model failure information, the UE may be configured to further receive, from the network device, a switch indication to switch to a second AI/ML model. The switch indication may be generated by the network device in response to the received model failure information. The switch indication may be received via various types of signaling from the network device to the UE, for example, an RRC signaling or a MAC CE message from the network device to the UE.

In optional embodiments, the second AI/ML model may be selected at least partly based on the one or more candidate AI/ML models that are preferred by the UE.

In alternative embodiments, the UE is not configured to locally compare the calculated values for the one or more inference quality metrics of the first AI/ML model with the one or more first preconfigured threshold values for the one or more inference quality metrics. Instead, the UE is configured to report, to the network device, calculated values for the one or more inference quality metrics of the first AI/ML model, and receive, from the network device, a switch indication to switch to the second AI/ML model that is different from the first AI/ML model. In other words, the network device may take the responsibility to determine the failure of the first AI/ML model based on the reported values for one or more inference quality metrics of the first AI/ML model and then indicate the determined failure status to the UE.

In some embodiments, the values for the one or more inference quality metrics of the first AI/ML model may be reported by the UE to the network device in a periodic manner. The periodic cycle at which the values are reported may be preconfigured by the network device, for example, at the time of deploying the first AI/ML model for use with the UE.

In other embodiments, the values for the one or more inference quality metrics of the first AI/ML model may be reported by the UE to the network device in response to one or more trigger events. The trigger events may be preconfigured by the network device, for example, at the time of deploying the first AI/ML model for use with the UE. An example of the trigger events may include values for the one or more inference quality metrics of the first AI/ML model not matching one or more second preconfigured threshold values. Again, a time-to-trigger mechanism may be used, such that the values for the one or more inference quality metrics are reported to the network device only if these values fail to match the one or more second preconfigured threshold values for a preconfigured time duration.

After detection of the failure status of the first AI/ML model, the process 600 may proceed to step 604. In this step, the UE may be configured to switch to a second AI/ML model that is different from the first AI/ML model. The switch may be performed in response to receiving a switch indication from the network device, as described above. The switch indication may be received via various types of signaling, including an RRC signaling or a MAC CE message.

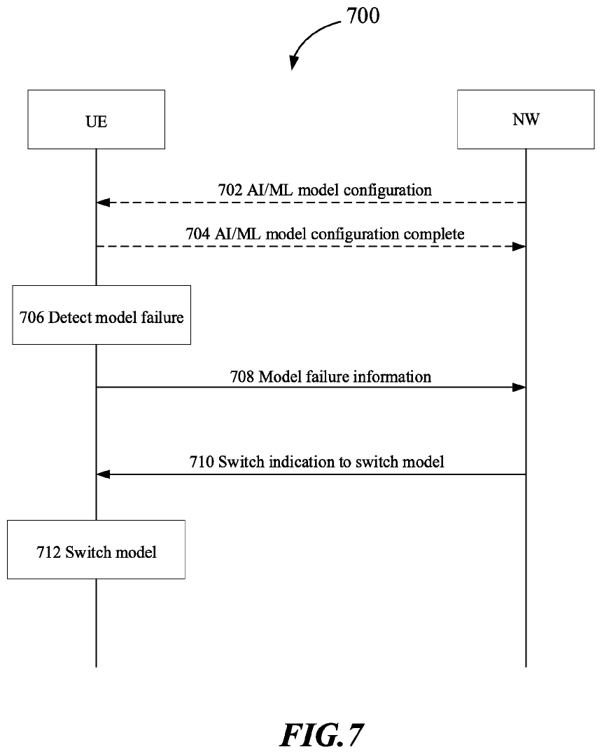

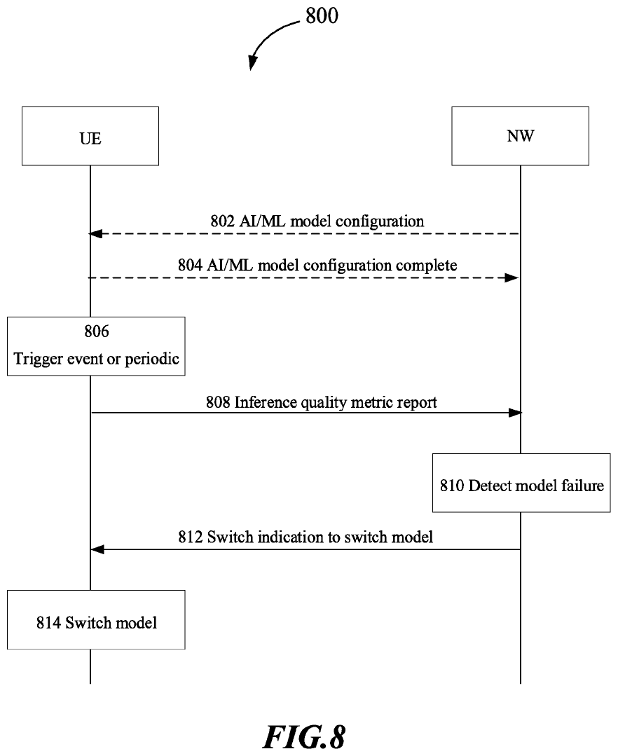

Additional details about performing fast recovery under model failure detection are described in combination with FIG. 7 and FIG. 8 below.

FIG. 7 illustrates a communication procedure 700 for performing fast recovery under model failure detection, according to embodiments disclosed herein. The UE may be a wireless device (such as the wireless device 202 described above) that is served by the network device. The network device may be a base station of a cellular network, such as the network device 218 described above. The communication procedure 700 may be performed by the UE and the network device, or by modules of the UE and the network device. In an example, the communication procedure 700 may be performed by processor(s) 204 of the wireless device 202 and processor(s) 220 of the network device 218, or by the model management module 216 of the wireless device 202 and the model management module 232 of the network device 218.

At step 702, the network device may be configured to send an AI/ML model configuration message to the UE so as to deploy one or more AI/ML models intended for use with the UE. The one or more AI/ML models may have been trained for the UE with the negotiated training quality for the UE, as described above. The AI/ML model configuration message may include an identifier of each of the intended AI/ML models, and optionally one or more settings (such as inference quality monitor fields) associated with that model. The AI/ML model configuration message may be carried in an RRCReconfiguration message.

In the example of FIG. 7, the inference quality monitor fields in the AI/ML model configuration may include a field of inference quality threshold (e.g., “InferenceQualityThreshold”). The field of inference quality threshold may specify the first preconfigured threshold values for the one or more inference quality metrics as described above. The UE may compare the received first preconfigured threshold values with the calculated values for the one or more inference quality metrics to determine if a running AI/ML model has failed (or, has a mismatch with the wireless environment).

Upon receiving the AI/ML model configuration message, the UE may be configured to deploy and run at least one AI/ML model that is indicated in the AI/ML model configuration message. The UE may further return an AI/ML model configuration complete message to the network device at step 704. The AI/ML model configuration complete message may be carried in an RRCReconfigurationComplete message.

Steps 702 and 704 are illustrated with dashed lines, since they are optional steps for performing fast recovery under model failure detection.

While running the AI/ML model, the UE may be configured to monitor the running AI/ML model for its failure. The UE may be configured to detect model failure of the AI/ML model at step 706. Specifically, the UE may detect the failure status of the AI/ML model by determining values for one or more inference quality metrics of the AI/ML model do not match one or more first preconfigured threshold values for the one or more inference quality metrics. The values for one or more inference quality metrics of the AI/ML model may be calculated by the UE using collected ground truths labels and inference output of the AI/ML model. For example, when the AI/ML model is applied to CSI feedback enhancement (such as CSI channel compression), the values for one or more inference quality metrics of the AI/ML model may be calculated by correlation between the original channel without compression with the compressed channel (which may be inference output of the AI/ML model). The one or more first preconfigured threshold values may be configured by the network device, for example, via the “InferenceQualityThreshold” field of the AI/ML model configuration message in step 702.

In optional embodiments, a time-to-trigger mechanism may be used in detecting the failure status. Specifically, only when the values for the one or more inference quality metrics of the AI/ML model fail to match the one or more first preconfigured threshold values for a preconfigured time duration, the UE will determine the AI/ML model has failed.

According to embodiments disclosed herein, the one or more inference quality metrics may include various metrics that may be able to measure quality of the inference output of the AI/ML model. Example of the inference quality metrics may include but not limited to:
inference accuracy of the AI/ML model (mean or variance);
inference integrity of the AI/ML model, which is associated with likelihood that a prediction error of the AI/ML model exceeds a threshold; or
inference latency of the AI/ML model, which indicates how long does it take for the model to output the inference result after receiving the input.

In response to detecting the failure status of the AI/ML model, the UE may be configured to send, to the network device, model failure information associated with the AI/ML model at step 708. The model failure information may be sent via various type of messages.

In an embodiment, the model failure information may be sent via an RRC message. The RRC message may include the failure status of the AI/ML model, indicating a mismatch of the AI/ML model with the wireless environment. Additionally, the RRC message may further include the calculated values of the inference quality metrics associated with the failed AI/ML model. In optional embodiments, the RRC message may further indicate one or more candidate AI/ML models that are preferred by the UE to switch to. The one or more candidate AI/ML models that are preferred by the UE may be determined based on implementation of the UE. In an embodiment, the RRC message may be a UE Assistance Information (UAI) message.

In an alternative embodiment, the model failure information may be sent via a MAC CE message, which may be referred to as a Model Failure Recovery (MFR) MAC CE message. Transmission of the MFR MAC CE message may serve as an indication of the failure status of the AI/ML model that is currently running with the UE. The MFR MAC CE message may also include indication of one or more candidate AI/ML models that are preferred by the UE to switch to. For example, the MFR MAC CE message may include a plurality of fields, each indicating whether a corresponding AI/ML model is preferred by the UE. In this example, the MFR MAC CE message may have the structure as shown in Table 1.

TABLE 1

| | | | | | | | |
|---|---|---|---|---|---|---|---|
| C7 | C6 | C5 | C4 | C3 | C2 | C1 | C0 |

tie breaker (optional)

As shown in the example of Table 1, the MFR MAC CE message may include eight fields C0-C7, each corresponding to a respective candidate AI/ML model that may be used with the UE. The UE may set a corresponding field of C0-C7 to a first predetermined value (e.g., 1) if the corresponding candidate AI/ML model is preferred by the UE. Also, the UE may set a corresponding field of C0-C7 to a second predetermined value (e.g., 0) if the corresponding candidate AI/ML model is not preferred by the UE. In some embodiments, the UE may set multiple fields to the first value so as to indicate a plurality of preferred AI/ML models. Optionally, the tie breaker field may provide additional information, for example, to facilitate a selection between the plurality of preferred AI/ML models.

In this embodiment, mapping between the fields C0-C7 and the corresponding AI/ML models may be preconfigured. For example, RRC configuration may include identifiers for the AI/ML models, and each of the identifiers may be configured to map to one of the fields C0-C7, for fast model recovery. It is readily understood that any suitable number of fields may be used, not limited to eight fields C0-C7.

In this embodiment where MFR MAC CE message is used to carry the model failure information, during a logical channel prioritization (LCP) procedure, the MFR MAC CE message may have a lower priority than a MAC CE message used for a number of Desired Guard Symbols and a higher priority than a MAC CE message used for Pre-emptive Buffer Status Report (BSR).

After receiving the model failure information, the network device may be configured to send a switch indication to the UE at step 710. In some embodiments, the switch indication may be sent via a RRC message or a MAC CE message. For example, the switch indication may be included in a RRCReconfiguration message. As an example, the network device may send an AI/ML model configuration message associated with a new AI/ML model, so as to instruct the UE to deploy the new AI/ML model, thereby replacing the AI/ML model that has been detected as failed.

In response to receiving the switch indication, the UE may be configured to switch to the new AI/ML model at step 712. For example, the UE may be configured to feed input to the new AI/ML model and gather inference output from the new model. The previous AI/ML model that has been detected as failed may be discarded by providing no input thereto. Additionally, the UE may send a successful indication to the network device. After switching to the new AI/ML model, the UE may keep monitoring the inference quality of the new AI/ML model.

FIG. 8 illustrates another communication procedure 800 for performing fast recovery under model failure detection, according to embodiments disclosed herein. The UE may be a wireless device (such as the wireless device 202 described above) that is served by the network device. The network device may be a base station of a cellular network, such as the network device 218 described above. The communication procedure 800 may be performed by the UE and the network device, or by modules of the UE and the network device. In an example, the communication procedure 800 may be performed by processor(s) 204 of the wireless device 202 and processor(s) 220 of the network device 218, or by the model management module 216 of the wireless device 202 and the model management module 232 of the network device 218.

At step 802, the network device may send an AI/ML model configuration message to the UE so as to deploy one or more AI/ML models intended for use with the UE. The one or more AI/ML models may have been trained for the UE with the negotiated training quality for the UE, as described above. The AI/ML model configuration message may include an identifier of each of the intended AI/ML models, and optionally one or more settings (such as inference quality monitor fields) associated with that model.

In the example of FIG. 8, the inference quality monitor fields in the AI/ML model configuration message may include a field of inference quality report configuration (e.g., “ReportConfigInferenceQuality”), which may specify properties of reporting the inference quality from the UE to the network device. The specified properties may include but not limited to trigger type (periodic or event-trigger), length of periodic cycle, and/or one or more trigger event.

Upon receiving the AI/ML model configuration message, the UE may be configured to deploy and run at least one AI/ML model that is indicated in the AI/ML model configuration message. Additionally, the UE may return an AI/ML model configuration complete message to the network device at step 804.

The AI/ML model configuration message may be carried in an RRCReconfiguration message and the AI/ML model configuration complete message may be carried in an RRCReconfigurationComplete message.

Steps 802 and 804 are illustrated with dashed lines, since they are optional steps for performing fast recovery under model failure detection.

While running the AI/ML model, the UE may be configured to monitor the AI/ML model and calculate values of one or more inference quality metrics of the AI/ML model. As discussed above, examples of the inference quality metrics may include but not limited to: inference accuracy of the AI/ML model (mean or variance); inference integrity of the AI/ML model, which is associated with likelihood that a prediction error of the AI/ML model exceeds a threshold; or inference latency of the AI/ML model, which indicates how long does it take for the model to output the inference result after receiving the input.

The calculation of values of the one or more inference quality metrics of the AI/ML model may be similar to that described above. Specifically, the UE may be configured to use collected ground truths labels and inference output of the AI/ML model to calculate the values for the one or more inference quality metrics of the first AI/ML model.

In the example of FIG. 8, the UE may be configured to report calculated values of one or more inference quality metrics to the network device in response to one or more trigger events or in a periodic manner. The occurrence of the trigger events or expiration of periodic cycles may be detected at step 806.

In an embodiment where the UE reports in a periodic manner, the UE may keep a periodic timer. Each time the periodic timer expires at the step 806, the UE may be triggered to report the calculated values of one or more inference quality metrics to the network device at step 808.

In another embodiment, the UE reports in response to occurrence of one or more predetermined trigger events. For example, a trigger event may occur when the calculated values for the one or more inference quality metrics of the current AI/ML model do not match one or more preconfigured threshold values. In a further example, the trigger event may occur when the calculated values for the quality metrics do not match the threshold values for a preconfigured time duration. Other trigger events may also be used. In detection of at least one of the trigger events at step 806, the UE may be triggered to report calculated values of one or more inference quality metrics to the network device at step 808.

After receiving the reported values of one or more inference quality metrics of the AI/ML model from the UE, the network device may be configured to detect the failure status of the AI/ML model at step 810. The detection of the failure status may be similar to that of step 706, but is performed by the network device. Specifically, the network device may detect the failure status of the AI/ML model by determining the reported calculated values for one or more inference quality metrics of the AI/ML model do not match one or more first preconfigured threshold values for the one or more inference quality metrics. Again, the time-to-trigger mechanism may be optionally applied.

The one or more first preconfigured threshold values may be different from the one or more preconfigured threshold values that are used for triggering the report. More specifically, the one or more first preconfigured threshold values may be higher than the one or more preconfigured threshold values that are used for triggering the report.

If the network device does not detect any failure of the AI/ML model at the step 810, the network device may take no further action and the communication procedure 800 may go back to step 806 to wait for the next trigger event or the next expiration of the periodic timer. If the network device detects the failure status of the AI/ML model at the step 810, the network device may be configured to send a switch indication to the UE at step 812. In some embodiments, the switch indication may be sent via a RRC message or a MAC CE message. For example, the switch indication may be included in a RRCReconfiguration message. More specifically, the network device may send an AI/ML model configuration message associated with a new AI/ML model, so as to instruct the UE to switch the new AI/ML model.

In response to receiving the switch indication, the UE may be configured to switch to the new AI/ML model at step 814. Additionally, the UE may send a successful indication to the network device. After switching to the new AI/ML model, the UE may keep monitoring and reporting the inference quality of the new AI/ML model.

With the methods described in the process 600 and/or communication procedures 700/800, the UE may be able to fast recovery under model failure detection.

Embodiments contemplated herein include an apparatus comprising means to perform one or more elements of the process 400 and/or 600, and/or communication procedures 500, 700, and/or 800. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the process 400 and/or 600, and/or communication procedures 500, 700, and/or 800. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the process 400 and/or 600, and/or communication procedures 500, 700, and/or 800. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the process 400 and/or 600, and/or communication procedures 500, 700, and/or 800. This apparatus may be, for example, an apparatus of a UE (such as a wireless device 202 that is a UE, as described herein).

Embodiments contemplated herein include a signal as described in or related to one or more elements of the process 400 and/or 600, and/or communication procedures 500, 700, and/or 800.

Embodiments contemplated herein include a computer program or computer program product comprising instructions, wherein execution of the program by a processor is to cause the processor to carry out one or more elements of the process 400 and/or 600, and/or communication procedures 500, 700, and/or 800. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the communication procedures 500, 700, and/or 800. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the communication procedures 500, 700, and/or 800. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the communication procedures 500, 700, and/or 800. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the communication procedures 500, 700, and/or 800. This apparatus may be, for example, an apparatus of a base station (such as a network device 218 that is a base station, as described herein).

Embodiments contemplated herein include a signal as described in or related to one or more elements of the communication procedures 500, 700, and/or 800.

Embodiments contemplated herein include a computer program or computer program product comprising instructions, wherein execution of the program by a processing element is to cause the processing element to carry out one or more elements of the communication procedures 500, 700, and/or 800. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
at least one antenna;
at least one radio coupled to the at least one antenna; and
a processor coupled to the at least one radio;
wherein the processor is configured to:
receive a training quality enquiry message from a network device, wherein the training quality enquiry message comprises enquiry information about one or more training quality metrics for training one or more Artificial Intelligence (AI) models of the UE; and
transmit a training quality response message to the network device, wherein the training quality response message comprises response information about the one or more training quality metrics for training the one or more AI models of the UE.

2. The UE of claim 1, wherein the one or more training quality metrics associated with one or more AI models comprise one or more of:
a minimum size of a dataset that is to be used for training the one or more AI models;
a maximum age of a dataset that is allowed to be used for training the one or more AI models;
a time budget for training the one or more AI models;
an allowed number of unwanted presences of missing values in a dataset used for training the one or more AI models; or
an allowed number of unwanted presences of outlier values in a dataset used for training the one or more AI models.

3. The UE of claim 1, wherein the enquiry information comprises one or more values that are specified by the network device for the one or more training quality metrics.

4. The UE of claim 1, wherein the enquiry information comprises a training quality class index that is mapped to the one or more training quality metrics based on a preconfigured mapping table.

5. The UE of claim 1, wherein the response information comprises a rejection indication or an acceptance indication that is provided by the UE with respect to at least one of one or more training quality metrics.

6. The UE of claim 1, wherein the response information comprises one or more values that are acceptable by the UE for at least one of the one or more training quality metrics.

7. The UE of claim 1, wherein the training quality enquiry message and the training quality response message are communicated via a pair of Radio Resource Control (RRC) messages.

8. The UE of claim 1, wherein the processor is further configured to exchange the UE's capability on AI with the network device.

9. The UE of claim 8, wherein the one or more training quality metrics are determined based on the UE's capability on AI.

10. The UE of claim 1, wherein the processor is configured to train the one or more AI models under the one or more training quality metrics.

11. A user equipment (UE), comprising:
at least one antenna;
at least one radio coupled to the at least one antenna; and
a processor coupled to the at least one radio;
wherein the processor is configured to:
detect a failure status of a first Artificial Intelligence (AI) model of the UE; and
switch to a second AI model that is different from the first AI model.

12. The UE of claim 11, wherein the processor is configured to detect the failure status of the first AI model by at least:
determining, by the processor of the UE, values for one or more inference quality metrics of the first AI model do not match one or more first preconfigured threshold values for the one or more inference quality metrics.

13. The UE of claim 12, wherein the first preconfigured threshold values for the one or more inference quality metrics are configured by a network device.

14. The UE of claim 12, wherein the one or more inference quality metrics of the first AI model comprise at least one of:
inference accuracy of the first AI model;
inference integrity of the first AI model, which is associated with likelihood that a prediction error of the first AI model exceeds a threshold; or
inference latency of the first AI model.

15. The UE of claim 12, wherein the processor is configured to use collected ground truths labels and inference output of the first AI model to calculate the values for the one or more inference quality metrics of the first AI model.

16. The UE of claim 12, wherein the failure status is detected if the values for the one or more inference quality metrics of the first AI model do not match the one or more first preconfigured threshold values for a preconfigured time duration.

17. The UE of claim 12, wherein the processor is configured to:
in response to detecting the failure status of the first AI model, send, to a network device, model failure information associated with the first AI model; and
receive, from the network device, a switch indication to switch to the second AI model.

18. The UE of claim 17, wherein the model failure information indicates one or more candidate AI models that are preferred by the UE.

19. The UE of claim 18, wherein the one or more candidate AI models that are preferred by the UE are determined based on implementation of the UE.

20. The UE of claim 17, wherein the model failure information is sent via an RRC message or a MAC CE message.

21-30. (canceled)
